(19) United States
(12) Patent Application Publication
(10) Pub. No.: US 2025/0300366 A1
(43) Pub. Date: Sep. 25, 2025

(54) MULTI-SIDED MILLIMETER WAVE ANTENNA ARRAY MODULE AND ASSOCIATED RADIO FREQUENCY (RF) INTEGRATED CIRCUIT (IC) BUMP PLACEMENT

(71) Applicant: QUALCOMM Incorporated, San Diego, CA (US)

(72) Inventors: Vasanthan RAGHAVAN, West Windsor Township, NJ (US); Mohammad Ali TASSOUDJI, San Diego, CA (US); Raghu Narayan CHALLA, San Diego, CA (US)

(21) Appl. No.: 18/611,666

(22) Filed: Mar. 20, 2024

(51) Int. Cl. H01Q 21/06; H01Q 1/22; H01Q 1/24

(52) U.S. Cl. CPC H01Q 21/065; H01Q 1/2283; H01Q 1/243

(57) ABSTRACT

Aspects described herein include a first antenna array disposed on a first surface of a first substrate in a first plane, where the first antenna array comprises a plurality of antenna elements in a first configuration and a second antenna array disposed on a second substrate in a second plane, where the second plane is different than and nonparallel with the first plane, one or more solder bump connections disposed on the first substrate, a millimeter wave (mmW) circuitry connected to the one or more solder bump connections, and a connector physically coupling the second substrate to the first substrate, wherein the mmW circuitry is coupled via the one or more solder bump connections to the first antenna array, the connector, and the second antenna array.

### FIELD

The present disclosure relates generally to electronics and wireless communications. For example, aspects of the present disclosure relate to multi-sided millimeter wave (mmW) antenna array modules, where antenna arrays in multiple different planes are electrically coupled to communication circuitry.

### BACKGROUND

Wireless communication devices and technologies are becoming ever more prevalent. Wireless communication devices generally transmit and receive communication signals. A communication signal is typically processed by a variety of different components and circuits. In some modern communication systems, many different wavelengths of electromagnetic waves can be used in a single device. Additionally, beamforming and/or multiple-input multiple-output (MIMO) communications can involve complex antenna arrays with multiple antenna elements. Supporting different communication paths for wireless communications can involve managing complex interactions among device elements while managing interactions and interference between elements supporting communications on the different paths.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

One aspect is a millimeter wave (mmW) module. In some aspects, the mmW module includes a first antenna array disposed on a first surface of a first substrate in a first plane, wherein the first antenna array is associated with a first ground plane, and wherein the first antenna array includes a plurality of antenna elements in a first configuration; a second antenna array disposed on a second substrate in a second plane, wherein the second antenna array is associated with a second ground plane, wherein the second plane is different than and nonparallel with (or angled with respect to) the first plane, wherein the second antenna array includes a plurality of antenna elements in a second configuration, and wherein the second configuration is different than the first configuration; one or more solder bump connections disposed on the first substrate; millimeter wave (mmW) circuitry connected to the one or more solder bump connections; and a connector physically coupling the second substrate to the first substrate, wherein the mmW circuitry is coupled via the one or more solder bump connections to the first antenna array, the connector, and the second antenna array.

In some aspects, the mmW module is configured where the first ground plane is larger than the second ground plane, and wherein the solder bump connection is disposed on a second surface of the first substrate opposite the first surface.

In some aspects, the mmW module is configured where the first substrate is disposed on a back surface of a device substrate; wherein the second substrate is disposed at a top end of the device substrate.

In some aspects, the mmW module is configured where the second substrate is disposed on a back surface of a device substrate; wherein the first substrate is disposed at a top end of the device substrate; and wherein a number of antenna elements in the first antenna array is greater than a number of antenna elements in the second antenna array.

In some aspects, the mmW module is configured where the one or more solder bump connections includes separate solder bump nodes for a plurality of polarization and frequency band signal paths.

In some aspects, the mmW module is configured where the one or more solder bump connections includes: a first solder bump node associated with a first high frequency band path for a first polarization; a second solder bump node associated with a second high frequency band path for a second polarization different from the first polarization; a third solder bump node associated with a first low frequency band path with the first polarization; and a fourth solder bump node associated with a second low frequency band path with the second polarization.

In some aspects, the mmW module is configured where the first configuration is a one element by four element array configuration; and wherein the second configuration is a two element by two element array configuration.

In some aspects, the mmW module is configured where the first plane is approximately perpendicular to the second plane.

In some aspects, the mmW module further includes: a third antenna array disposed on a third substrate in a third plane, wherein the third plane is different from the first plane and the second plane, and wherein the third antenna array includes a plurality of antenna elements in a third configuration.

In some aspects, the mmW module is configured where the third plane is approximately perpendicular to the first plane and the second plane.

In some aspects, the mmW module is configured where the first configuration is a two element by four element array configuration, wherein the second configuration is a one element by four element array configuration, and wherein the third configuration is a one element by four element array configuration.

In some aspects, the mmW module is configured where the third plane is approximately perpendicular to the first plane and approximately parallel to the second plane.

In some aspects, the mmW module is configured where the first configuration is a one element by three element array configuration, wherein the second configuration is a two element by one element array configuration, and wherein the third configuration is a one element by three element array configuration.

In some aspects, the techniques described herein relate to a mmW module, wherein: the first configuration is a one element by two element array configuration, the second configuration is a one element by three element array configuration, and the third configuration is a one element by three element array configuration; and the third antenna array is offset from the second antenna array, such that a middle array element of the second antenna array is adjacent to a side array element of the third antenna array.

In some aspects, the mmW module is configured where the third plane is approximately parallel to the first plane and approximately perpendicular to the second plane.

In some aspects, the mmW module is configured where the mmW module is integrated within a wireless transceiver of a wireless communication apparatus.

In some aspects, the techniques described herein relate to a millimeter wave (mmW) module including: a first antenna array disposed on a first substrate in a first plane, wherein the first antenna array is associated with a first ground plane; a second antenna array disposed on a second substrate in a second plane, wherein the second antenna array is associated with a second ground plane, wherein the second plane is different than and nonparallel with (or angled with respect to) the first plane; a third antenna array disposed on a third substrate, wherein the third antenna array is associated with a third ground plane; one or more solder bump connections disposed on the first substrate; mmW circuitry connected to the one or more solder bump connections; a first connector physically coupling the second substrate to the first substrate; and a second connector physically coupling the third substrate to the first substrate or the second substrate, wherein the mmW circuitry is coupled via the one or more solder bump connections to the first antenna array, the first connector, the second antenna array, the second connector, and the third antenna array.

In some aspects, the mmW module is configured where the one or more solder bump connections includes separate solder bump nodes for a plurality of polarization and frequency band signal paths.

In some aspects, the mmW module is configured where the one or more solder bump connections include: a first solder bump node associated with a first high frequency band path for a first polarization; a second solder bump node associated with a second high frequency band path for a second polarization different from the first polarization; a third solder bump node associated with a first low frequency band path with the first polarization; and a fourth solder bump node associated with a second low frequency band path with the second polarization.

In some aspects, the techniques described herein relate to a millimeter wave (mmW) module including: a first antenna array disposed on a first surface of a first substrate in a first plane, wherein the first antenna array is associated with a first ground plane, and wherein the first antenna array includes a plurality of antenna elements in a first configuration; a second antenna array disposed on a second substrate in a second plane, wherein the second antenna array is associated with a second ground plane, wherein the second plane is different than the first plane, wherein the second antenna array includes a plurality of antenna elements in a second configuration; mmW circuitry; and means for electrically coupling the mmW circuitry with the first antenna array and the second antenna array, wherein the means for electrically coupling includes a plurality of solder bump connections on the first substrate which are nearer to an edge of the first substrate closest the second antenna array than they are to a center of the first substrate.

In some aspects, the apparatuses described above can include a mobile device with a camera for capturing one or more pictures. In some aspects, the apparatuses described above can include a display screen for displaying one or more pictures. In some aspects, additional wireless communication circuitry. The summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and aspects, will become more apparent upon referring to the following specification, claims, and accompanying drawings.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a diagram showing a wireless communication system communicating with a wireless device that can be implemented according to aspects described herein.

FIG. 2A is a block diagram showing portions of a wireless device in which aspects of the present disclosure may be implemented.

FIG. 2B is a block diagram showing portions of a wireless device in which aspects of the present disclosure may be implemented.

FIG. 2C is a block diagram illustrating aspects of a wireless device in which aspects of the present disclosure may be implemented.

FIGS. 3A, 3B, 3C and 3D are block diagrams illustrating a mmW module in accordance with aspects of the disclosure.

FIGS. 4A, 4B, 4C, and 4D are diagrams illustrating aspects of multi-sided antenna array modules in accordance with some aspects described herein.

FIG. 5 is a diagram illustrating aspects of multi-sided antenna array modules in accordance with some aspects described herein.

FIG. 6 is a diagram illustrating aspects of multi-sided antenna array modules in accordance with some aspects described herein.

FIG. 7A is a diagram illustrating aspects of multi-sided antenna array modules in accordance with some aspects described herein.

FIG. 7B is a diagram illustrating aspects of multi-sided antenna array modules in accordance with some aspects described herein.

FIG. 8 is a functional block diagram of an apparatus including a multi-sided antenna array module in accordance with some aspects described herein.

### DETAILED DESCRIPTION

The detailed description set forth below in connection with the appended drawings is intended as a description of exemplary implementations and is not intended to represent the only implementations in which the subject matter described herein may be practiced. The term “exemplary” used throughout the description means “serving as an example, instance, or illustration,” and should not necessarily be construed as preferred or advantageous over other exemplary implementations. The detailed description includes specific details for the purpose of providing a thorough understanding of the exemplary implementations. In some instances, some devices are shown in block diagram form. Drawing elements that are common among the following figures may be identified using the same reference numerals.

Standard form factors for devices, such as cell phones, tablets, laptop computers, cellular hotspot devices, among other such devices, are subject to increasingly limited space. At the same time, additional wireless communication systems are being integrated into such devices. Performance and space tradeoffs are design considerations in all such devices. The addition of millimeter wavelength (mmW) modules that include mmW circuitry, transmission (Tx) and receiver (Rx) elements for mmW communications are one form of additional functionality that have been added to devices. Such devices and other supporting infrastructure devices for communication systems described herein can use multiple antennas to support beamforming and other wireless communication technologies. Systems with multiple antenna modules have antenna elements that can be provided phase signals/excitations for beamforming, and can facilitate spherical (e.g., omnidirectional) communication coverage even when hand or body blockages are considered and dominant line-of-sight or non-line-of-sight paths can arrive from anywhere over a sphere around the user equipment (UE) (e.g., user cell phone). Such modules can additionally be used for design robustness and beam switching using the multiple antenna modules. The use of multiple modules, particularly for mmW communications, involves significant cost and space usage, along with additional complexity for signal handling, particularly in view of signal losses along short distances for wired mmW signals inside of a device. The performance losses associated with shifting from a multiple-module design to a single-module system can, to some extent, be offset by using a single multi-sided mmW module, where a single module can include multiple antenna arrays in different planes to facilitate omnidirectional communication.

The wired connection for a multi-sided three-dimensional antenna array, or a module with multiple arrays in different planes, can introduce additional device complexity. In a two-dimensional array, a solder bump connection is placed centrally to limit feedline or connection lengths from the solder bump connection to the individual antenna elements. However, in an antenna module geometry with multiple sides in different planes, the placement of this connection point is more complex. Multiple tradeoffs are present for optimization of the positioning. This includes a tradeoff for placement near different ground planes for different arrays, feedline losses, losses associated with connectors between the substrates for the separate antennas in different arrays, thermal considerations, and size considerations associated with substrate thickness at the solder bump placement location and space usage from fan-out connections originating at the solder bump placement location.

Aspects described herein include systems, devices, and multi-sided mmW antenna modules with solder bump placement for antenna element connections selected according to positioning design limitations as described below. In some aspects, the solder bump location is placed centrally on a substrate for the antenna module having the largest ground plane. This can include modules with two, three, or more substrates positioned approximately in two or more different planes or planar orientations.

In other aspects, the solder bump can be positioned either on an antenna substrate positioned on a top surface of a module substrate, or an antenna substrate positioned on an edge surface of the module substrate. For a given implementation, the position of the solder bump connection can be selected to improve peak performance by providing lower losses at the antenna array including the solder bump connection and higher losses to the antenna array(s) not including the solder bump connection. In such aspects, placement of the solder bump can be selected based on design performance to maximize the performance of the overall system.

Additional aspects and details are provided below with respect to the figures.

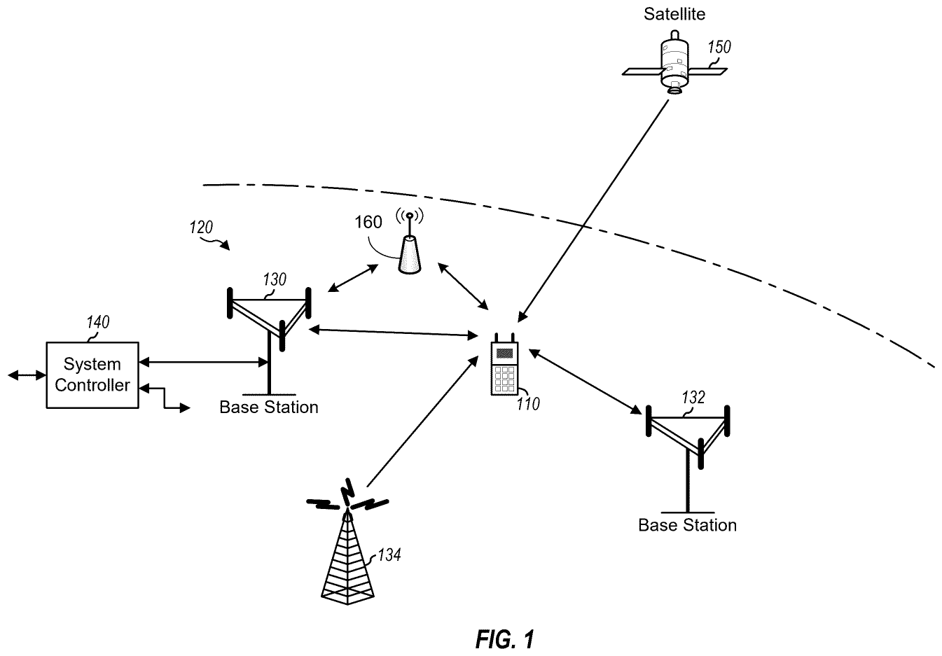

FIG. 1 is a diagram showing a wireless device 110 communicating with a wireless communication system 120. In accordance with aspects described herein, the wireless device can include a multi-sided mmW antenna in accordance with aspects described herein. The wireless communication system 120 may be a Long Term Evolution (LTE) system, a Code Division Multiple Access (CDMA) system, a Global System for Mobile Communications (GSM) system, a wireless local area network (WLAN) system, a 5G NR (new radio) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. Communication elements of the wireless device 110 for implementing mmW communications in accordance with any such communication standards can be supported by various designs (e.g., antennas) in accordance with aspects described herein. For simplicity, FIG. 1 shows wireless communication system 120 including two base stations 130 and 132 and one system controller 140. In general, a wireless communication system may include any number of base stations and any set of network entities.

The wireless device 110 may also be referred to as a user equipment (UE), a mobile station, a terminal, an access terminal, a subscriber unit, a station, etc. Wireless device 110 may be a cellular phone, a smartphone, a tablet, or other such mobile device (e.g., a device integrated with a display screen). Other examples of the wireless device 110 include a wireless modem, a personal digital assistant (PDA), a handheld device, a laptop computer, a smartbook, a netbook, a tablet, a cordless phone, a medical device, a device configured to connect to one or more other devices (e.g., through the internet of things), a wireless local loop (WLL) station, a Bluetooth device, etc. Wireless device 110 may communicate with wireless communication system 120. Wireless device 110 may also receive signals from broadcast stations (e.g., a broadcast station 134) and/or signals from satellites (e.g., a satellite 150 in one or more global navigation satellite systems (GNSS), etc.). Wireless device 110 may support one or more radio technologies for wireless communication such as LTE, WCDMA, CDMA 1X, EVDO, TD-SCDMA, GSM, 802.11, 5G, etc.

The wireless communication system 120 may also include a wireless device 160. In an exemplary aspect, the wireless device 160 may be a wireless access point, or another wireless communication device that comprises, or comprises part of a wireless local area network (WLAN). In an exemplary aspect, the wireless device 110 may be referred to as a customer premises equipment (CPE), which may be in communication with a base station 130 and a wireless device 110, or other devices in the wireless communication system 120. In some aspects, the CPE may be configured to communicate with the wireless device 160 using WAN signaling and to interface with the base station 130 based on such communication instead of the wireless device 160 directly communicating with the base station 130. In exemplary aspects where the wireless device 160 is configured to communicate using WLAN signaling, a WLAN signal may include WiFi, or other communication signals.

Wireless device 110 may support carrier aggregation, for example, as described in one or more LTE or 5G standards. In some aspects, a single stream of data is transmitted over multiple carriers using carrier aggregation, for example, as opposed to separate carriers being used for respective data streams. Wireless device 110 may be able to operate in a variety of communication bands including, for example, those communication bands used by LTE, WiFi, 5G or other communication bands, over a wide range of frequencies. Wireless device 110 may also be capable of communicating directly with other wireless devices without communicating through a network.

In general, carrier aggregation (CA) may be categorized into two types-intra-band CA and inter-band CA. Intra-band CA refers to operation on multiple carriers within the same band. Inter-band CA refers to operation on multiple carriers in different bands.

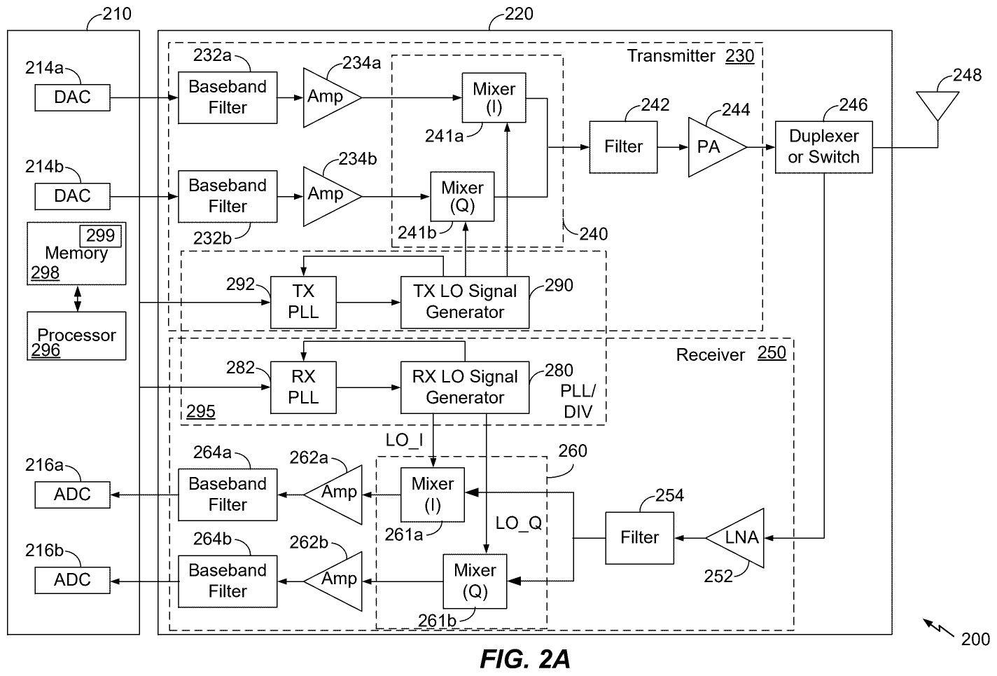

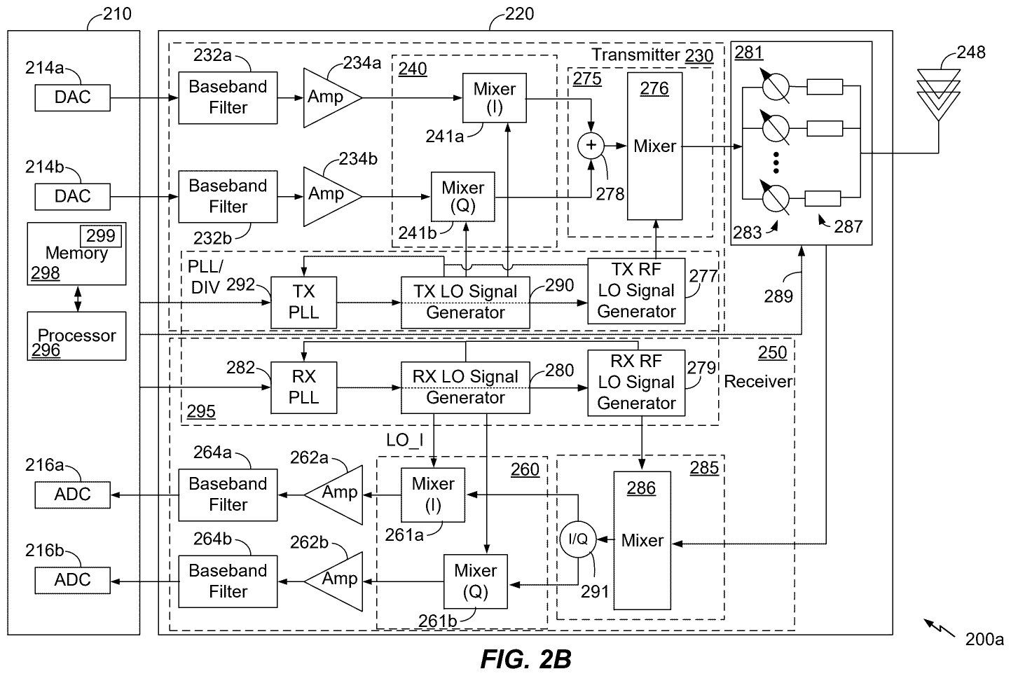

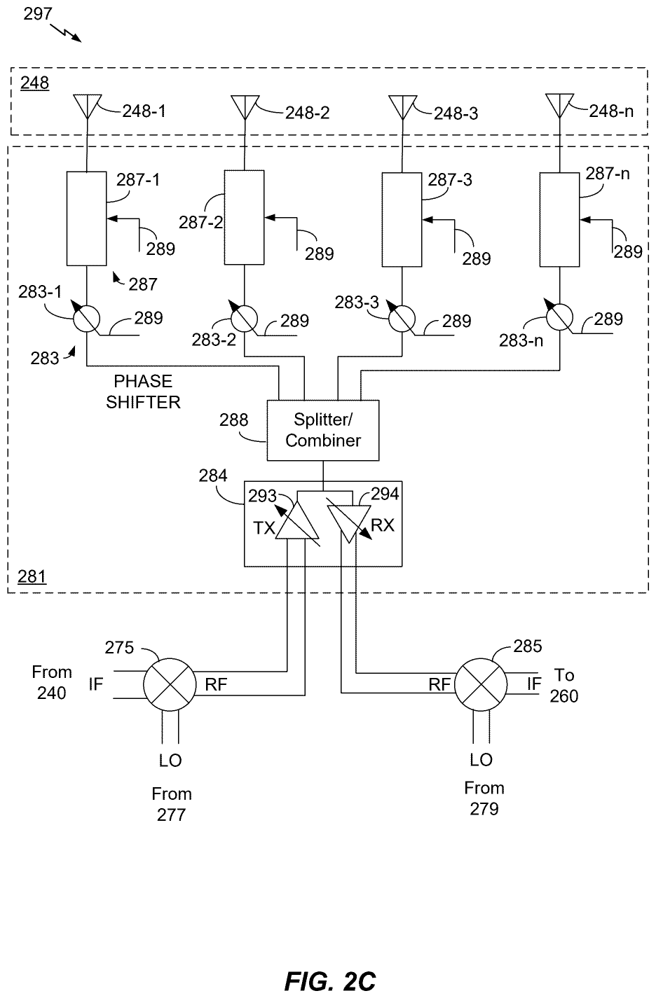

FIG. 2A is a block diagram showing a wireless device 200 in which aspects of the present disclosure may be implemented. The wireless device 200 may, for example, be an aspect of the wireless device 110 illustrated in FIG. 1. The circuitry described may be circuitry supporting mmW communications that can further be configured with a multi-sided mmW module having antenna arrays disposed in different (e.g., perpendicular) planes and may support omnidirectional communications in accordance with aspects described herein.

FIG. 2A shows an example of a transceiver 220 having a transmitter 230 and a receiver 250. In general, the conditioning of the signals in the transmitter 230 and the receiver 250 may be performed by one or more stages of amplifier, filter, upconverter, downconverter, etc. These circuit blocks may be arranged differently from the configuration shown in FIG. 2A. Furthermore, other circuit blocks not shown in FIG. 2A may also be used to condition the signals in the transmitter 230 and receiver 250. Unless otherwise noted, any signal in FIG. 2A, or any other figure in the drawings, may be either single-ended or differential. Some circuit blocks in FIG. 2A may also be omitted.

In the example shown in FIG. 2A, wireless device 200 generally comprises the transceiver 220 and a data processor 210. The data processor 210 may include a processor 296 operatively coupled to a memory 298. The memory 298 may be configured to store data and program codes shown generally using reference numeral 299, and may generally comprise analog and/or digital processing components. The transceiver 220 includes a transmitter 230 and a receiver 250 that support bi-directional communication. In general, wireless device 200 may include any number of transmitters and/or receivers for any number of communication systems and frequency bands. All or a portion of the transceiver 220 may be implemented on one or more analog integrated circuits (ICs), RFICs (RFICs), mixed-signal ICs, etc.

A transmitter or a receiver may be implemented with a super-heterodyne architecture or a direct-conversion architecture. In the super-heterodyne architecture, a signal is frequency-converted between radio frequency (RF) and baseband in multiple stages, e.g., from RF to an intermediate frequency (IF) in one stage, and then from IF to baseband in another stage for a receiver. In the direct-conversion architecture, a signal is frequency converted between RF and baseband in one stage. The super-heterodyne and direct-conversion architectures may use different circuit blocks and/or have different requirements. In the example shown in FIG. 2A, transmitter 230 and receiver 250 are implemented with the direct-conversion architecture.

In the transmit path, the data processor 210 processes data to be transmitted and provides in-phase (I) and quadrature (Q) analog output signals to the transmitter 230. In an exemplary aspect, the data processor 210 includes digital-to-analog-converters (DAC's) 214a and 214b for converting digital signals generated by the data processor 210 into the I and Q analog output signals, e.g., I and Q output currents, for further processing. In other aspects, the DACs 214a and 214b are included in the transceiver 220 and the data processor 210 provides data (e.g., for I and Q) to the transceiver 220 digitally.

Within the transmitter 230, lowpass filters 232a and 232b filter the I and Q analog transmit signals, respectively, to remove undesired images caused by the prior digital-to-analog conversion. Amplifiers (Amp) 234a and 234b amplify the signals from lowpass filters 232a and 232b, respectively, and provide I and Q baseband signals. An upconverter 240 having upconversion mixers 241a and 241b upconverts the I and Q baseband signals with I and Q transmit (TX) local oscillator (LO) signals from a TX LO signal generator 290 and provides an upconverted signal. A filter 242 filters the upconverted signal to remove undesired images caused by the frequency upconversion as well as noise in a receive frequency band. A power amplifier 244 amplifies the signal from filter 242 to obtain the desired output power level and provides a transmit RF signal. The transmit RF signal is routed through a duplexer or switch 246 and transmitted via an antenna array 248. As described herein, the antenna array 248 can be configured as multiple supported antenna arrays having different directionality (e.g., positioning in different planes) in accordance with aspects described herein. Additionally, while examples discussed herein utilize I and Q signals, those of skill in the art will understand that components of the transceiver may be configured to utilize polar modulation.

In the receive path, the antenna array 248 (e.g., or multiple arrays 248) receives communication signals and provides a received RF signal, which is routed through duplexer or switch 246 and provided to a low noise amplifier (LNA) 252. The switch 246 is designed to operate with a specific RX-to-TX duplexer frequency separation, such that RX signals are isolated from TX signals. The received RF signal is amplified by LNA 252 and filtered by a filter 254 to obtain a desired RF input signal. Downconversion mixers 261a and 261b in a downconverter 260 mix the output of filter 254 with I and Q receive (RX) LO signals (i.e., LO_I and LO_Q) from an RX LO signal generator 280 to generate I and Q baseband signals. The I and Q baseband signals are amplified by amplifiers 262a and 262b and further filtered by lowpass filters 264a and 264b to obtain I and Q analog input signals, which are provided to data processor 210. In the exemplary aspect shown, the data processor 210 includes analog-to-digital-converters (ADC's) 216a and 216b for converting the analog input signals into digital signals to be further processed by the data processor 210. In some aspects, the ADCs 216a and 216b are included in the transceiver 220 and provide data to the data processor 210 digitally. For a multi-sided single mmW module, direction finding operations or other such processes can be used to determine the directionality associated with signals.

In FIG. 2A, TX LO signal generator 290 generates the I and Q TX LO signals used for frequency upconversion, while RX LO signal generator 280 generates the I and Q RX LO signals used for frequency downconversion. Each LO signal is a periodic signal with a particular fundamental frequency. A phase locked loop (PLL) 292 receives timing information from data processor 210 and generates a control signal used to adjust the frequency and/or phase of the TX LO signals from LO signal generator 290. Similarly, a PLL 282 receives timing information from data processor 210 and generates a control signal used to adjust the frequency and/or phase of the RX LO signals from LO signal generator 280.

In an exemplary aspect, the RX PLL 282, the TX PLL 292, the RX LO signal generator 280, and the TX LO signal generator 290 may alternatively be combined into a single LO generator circuit 295, which may include common or shared LO signal generator circuitry to provide the TX LO signals and the RX LO signals. Alternatively, separate LO generator circuits may be used to generate the TX LO signals and the RX LO signals.

Wireless device 200 may support CA and may (i) receive multiple downlink signals transmitted by one or more cells on multiple downlink carriers at different frequencies and/or (ii) transmit multiple uplink signals to one or more cells on multiple uplink carriers. Those of skill in the art will understand, however, that aspects described herein may be implemented in systems, devices, and/or architectures that do not support carrier aggregation.

Certain components of the transceiver 220 are functionally illustrated in FIG. 2A, and the configuration illustrated therein may or may not be representative of a physical device configuration in certain implementations. For example, as described above, transceiver 220 may be implemented in various integrated circuits (ICs), RF ICs (RFICs), mixed-signal ICs, etc. In some aspects, the transceiver 220 is implemented on a substrate or board such as a printed circuit board (PCB) having various modules, chips, and/or components. For example, the power amplifier 244, the filter 242, and the switch 246 may be implemented in separate modules or as discrete components, while the remaining components illustrated in the transceiver 220 may be implemented in a single transceiver chip.

The power amplifier 244 may comprise one or more stages comprising, for example, driver stages, power amplifier stages, or other components, that can be configured to amplify a communication signal on one or more frequencies, in one or more frequency bands, and at one or more power levels. Depending on various factors, the power amplifier 244 can be configured to operate using one or more driver stages, one or more power amplifier stages, one or more impedance matching networks, and can be configured to provide good linearity, efficiency, or a combination of good linearity and efficiency.

In an exemplary aspect in a super-heterodyne architecture, the filter 242, power amplifier 244, LNA 252 and filter 254 may be implemented separately from other components in the transmitter 230 and receiver 250, and may be implemented on a millimeter wave integrated circuit. An example super-heterodyne architecture is illustrated in FIG. 2B.

FIG. 2B is a block diagram showing a wireless device in which aspects of the present disclosure may be implemented. Certain components of the wireless device 200a in FIG. 2B, which may be indicated by identical reference numerals, may be configured similarly to those in the wireless device 200 shown in FIG. 2A and the description of identically numbered items in FIG. 2B will not be repeated.

The wireless device 200a is an example of a heterodyne (or superheterodyne) architecture in which the upconverter 240 and the downconverter 260 are configured to process a communication signal between baseband and an intermediate frequency (IF). For example, the upconverter 240 may be configured to provide an IF signal to an upconverter 275. In an exemplary aspect, the upconverter 275 may comprise summing function 278 and upconversion mixer 276. The summing function 278 combines the I and the Q outputs of the upconverter 240 and provides a non-quadrature signal to the mixer 276. The non-quadrature signal may be single ended or differential. The mixer 276 is configured to receive the IF signal from the upconverter 240 and TX RF LO signals from a TX RF LO signal generator 277, and provide an upconverted mmW signal to phase shift circuitry 281. While PLL 292 is illustrated in FIG. 2B as being shared by the signal generators 290, 277, a respective PLL for each signal generator may be implemented.

In an exemplary aspect, components in the phase shift circuitry 281 may comprise one or more adjustable or variable phased array elements, and may receive one or more control signals from the data processor 210 over connection 289 and operate the adjustable or variable phased array elements based on the received control signals.

In an exemplary aspect, the phase shift circuitry 281 comprises phase shifters 283 and phased array elements 287. Although three phase shifters 283 and three phased array elements 287 are shown for case of illustration, the phase shift circuitry 281 may comprise more or fewer phase shifters 283 and phased array elements 287.

Each phase shifter 283 may be configured to receive the mmW transmit signal from the upconverter 275, alter the phase by an amount, and provide the mmW signal to a respective phased array element 287. Each phased array element 287 may comprise transmit and receive circuitry including one or more filters, amplifiers, driver amplifiers, and power amplifiers. In some aspects, the phase shifters 283 may be incorporated within respective phased array elements 287.

The output of the phase shift circuitry 281 is provided to an antenna array 248. In an exemplary aspect, the antenna array 248 comprises a number of antennas that typically correspond to the number of phase shifters 283 and phased array elements 287, for example, such that each antenna element is coupled to a respective phased array element 287. In an exemplary aspect, the phase shift circuitry 281 and the antenna array 248 may be referred to as a phased array.

In a receive direction, an output of the phase shift circuitry 281 is provided to a downconverter 285. In an exemplary aspect, the downconverter 285 may comprise an I/Q generation function 291 and a downconversion mixer 286. In an exemplary aspect, the mixer 286 downconverts the receive mmW signal provided by the phase shift circuitry 281 to an IF signal according to RX mmW LO signals provided by an RX mmW LO signal generator 279. The I/Q generation function 291 receives the IF signal from the mixer 286 and generates I and Q signals for the downconverter 260, which downconverts the IF signals to baseband, as described above. While PLL 282 is illustrated in FIG. 2B as being shared by the signal generators 280, 279, a respective PLL for each signal generator may be implemented.

In some aspects, the upconverter 275, downconverter 285, and the phase shift circuitry 281 are implemented on a common IC. In some aspects, the summing function 278 and the I/Q generation function 291 are implemented separate from the mixers 276 and 286 such that the mixers 276, 286 and the phase shift circuitry 281 are implemented on the common IC, but the summing function 278 and I/Q generation function 291 are not (e.g., the summing function 278 and I/Q generation function 291 are implemented in another IC coupled to the IC having the mixers 276, 286). In some aspects, the LO signal generators 277, 279 are included in the common IC. In some aspects in which phase shift circuitry is implemented on a common IC with 276, 286, 277, 278, 279, and/or 291, the common IC and the antenna array 248 are included in a module, which may be electrically coupled to other components of the transceiver 220 via a connector. In some aspects, the phase shift circuitry 281, for example, a chip on which the phase shift circuitry 281 is implemented, is coupled to the antenna array 248 by an interconnect. For example, components of the antenna array 248 may be implemented on a substrate and coupled to an integrated circuit implementing the phase shift circuitry 281 via a flexible printed circuit board or other such substrate.

In some aspects, both the architecture illustrated in FIG. 2A and the architecture illustrated in FIG. 2B are implemented in the same device. For example, a wireless device 110 or 200 may be configured to communicate with signals having a frequency below about 10 GHz using the architecture illustrated in FIG. 2A and to communicate with signals having a frequency above about 10 GHz using the architecture illustrated in FIG. 2B. In devices in which both architectures are implemented, one or more components of FIGS. 2A and 2B that are identically numbered may be shared between the two architectures. For example, both signals that have been downconverted directly to baseband from mmW and signals that have been downconverted from mmW to baseband via an IF stage may be filtered by the same baseband filter 264a, 264b. In other aspects, a first version of the filter 264 is included in the portion of the device which implements the architecture of FIG. 2A and a second version of the filter 264 is included in the portion of the device which implements the architecture of FIG. 2B.

FIG. 2C is a block diagram 297 showing in greater detail an aspect of some of the components of FIG. 2B. In an exemplary aspect, the upconverter 275 provides an mmW transmit signal to the phase shift circuitry 281 and the downconverter 285 receives an mmW receive signal from the phase shift circuitry 281. In an exemplary aspect, the phase shift circuitry 281 comprises an mmW variable gain amplifier (VGA) 284, a splitter/combiner 288, the phase shifters 283 and the phased array elements 287. In an exemplary aspect, the phase shift circuitry 281 may be implemented on a millimeter-wave integrated circuit (mmW IC). In some such aspects, the upconverter 275 and/or the downconverter 285 (or just the mixers 276, 286) are also implemented on the mmWIC. In an exemplary aspect, the mmW VGA 284 may comprise a TX VGA 293 and an RX VGA 294. In some aspects, the TX VGA 293 and the RX VGA 294 may be implemented independently. In other aspects, the VGA 284 is bidirectional. In an exemplary aspect, the splitter/combiner 288 may be an example of a power distribution network and a power combining network. In some aspects, the splitter/combiner 288 may be implemented as a single component or as a separate signal splitter and signal combiner. The phase shifters 283 are coupled to respective phased array elements 287. Each respective phased array element 287 is coupled to a respective antenna element in the antenna array 248. In an exemplary aspect, phase shifters 283 and the phased array elements 287 receive control signals from the data processor 210 over connection 289. The exemplary aspect shown in FIG. 2C comprises a 1×4 array having four phase shifters 283-1, 283-2, 283-3 and 283-n, four phased array elements 287-1, 287-2, 287-3 and 287-n, and four antennas 248-1, 248-2, 248-3 and 248-n. However, a 1×4 phased array is shown for example purposes only, and other configurations, such as 1×2, 1×6, 1×8, 2×3, 2×4, or other configurations are possible. Further, such a structure can support multi-sided antenna structures as described below, with multiple arrays each having structure to support phase shifting for each side of the antenna structure of implementations described below, or other such implementations.

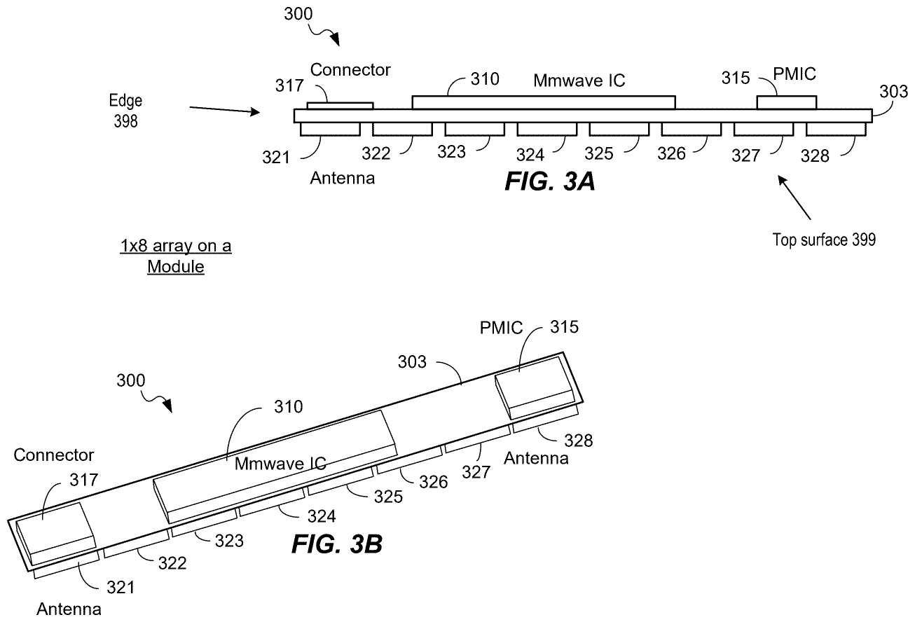

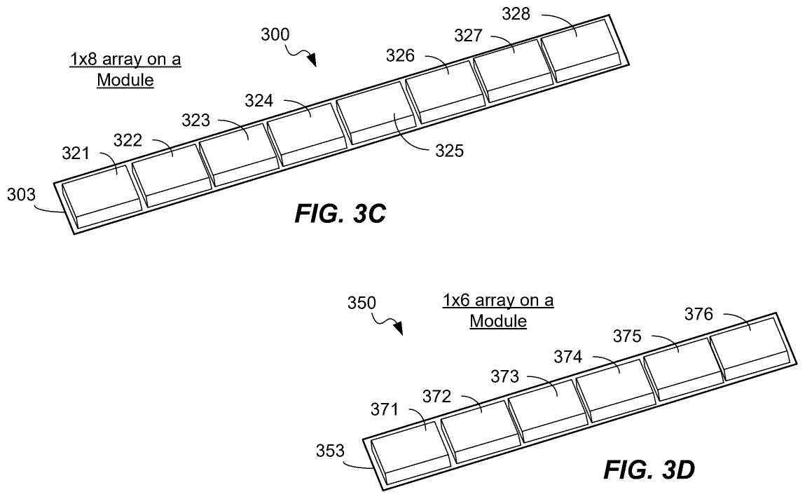

FIGS. 3A, 3B, 3C, and 3D are block diagrams collectively illustrating some aspects of a millimeter wave (mmW) module in accordance with some aspects of the disclosure. The circuitry above illustrates mmW elements that can be disposed in a mmW module (e.g., in a mmW PCB or module substrate). The elements of the mmW antenna arrays described show a single antenna array disposed on a top surface of a module substrate. The additional antenna arrays described below can include antenna arrays disposed on edges or opposite surfaces to create a multi-sided antenna system in accordance with aspects described herein.

FIG. 3A shows a side view of a millimeter wave (mmW) module 300. The illustrated mmW module 300 comprises a 1×8 phased array fabricated on a top surface 399 of a module substrate 303. In some aspects, the mmW module 300 may comprise a mmW IC 310, a PMIC 315, a connector 317 and a plurality of antennas elements 321, 322, 323, 324, 325, 326, 327 and 328 fabricated on the top surface 399 module substrate 303. The connector 317 may be used to couple the mmW IC to circuitry external to the module 300, for example to a intermediate frequency (IF) and/or baseband circuit. For illustration purposes, the mmW module 300 shows the structure with a single antenna array with the illustrated antenna elements 321, 322, 323, 324, 325, 326, 327 and 328. The antenna elements 321, 322, 323, 324, 325, 326, 327 and 328 are illustrated separately (e.g., each implemented in a separate stackup, on a separate substrate/board, etc.), but two or more of the antenna elements may be implemented on a common board and/or integrated with the module substrate 303. Aspects in accordance with aspects described herein will include additional arrays along other sides (e.g., along the edge 398, the backside surface, etc.). Other components may be included in the module 300, but are omitted from the illustration in FIG. 3A. The mmW IC 310 may include elements or circuitry as described above, for example with respect to FIGS. 2A-2C. FIG. 3B is a top perspective view of the mmW module 300 showing the mmW IC 310, a PMIC 315, a connector 317 and a plurality of antenna elements 321, 322, 323, 324, 325, 326, 327 and 328 on the module substrate 303. FIG. 3C is a bottom perspective view of the mmW module 300 showing the antennas elements 321, 322, 323, 324, 325, 326, 327 and 328 on the module substrate 303. FIG. 3D shows an alternative aspect of a millimeter wave (mmW) module 350. The mmW module 350 may be similar to the mmW module 300 shown in FIG. 3A, but is arranged as a 1×6 array. In some aspects, the mmW module 350 may comprise a 1×6 phased array fabricated on a substrate 353. In some aspects, the mmW module 350 may comprise a plurality of antenna elements 371, 372, 373, 374, 375 and 376 fabricated on the substrate 353.

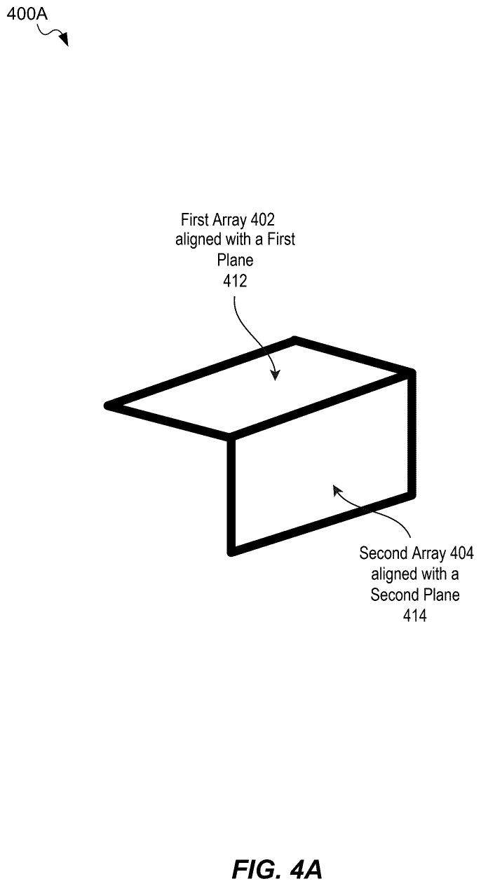

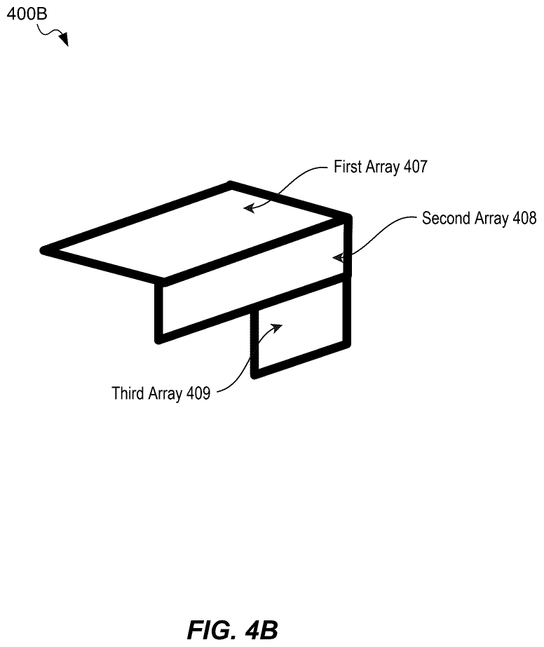

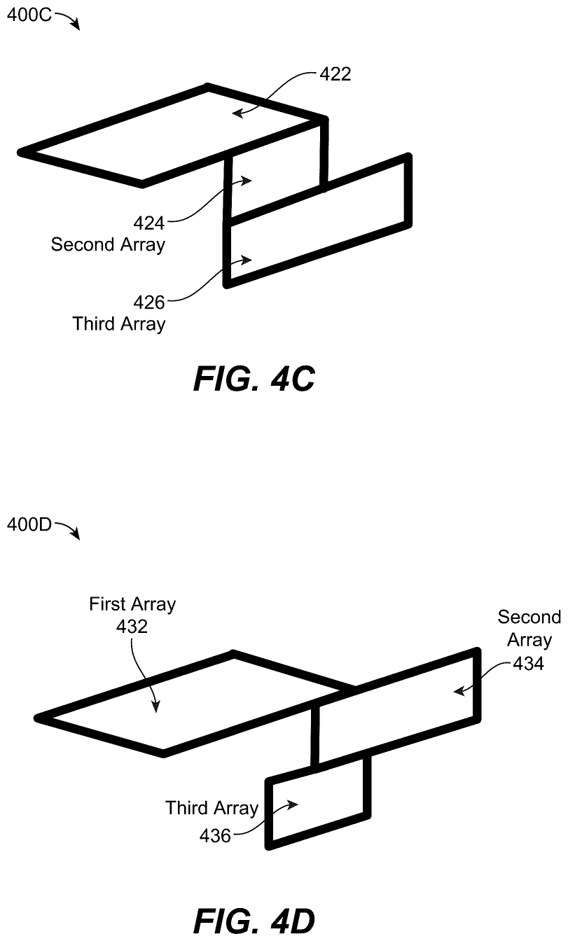

FIGS. 4A, 4B, 4C, and 4D are diagrams illustrating aspects of multi-sided antenna array modules in accordance with some aspects described herein. For example, FIG. 4A illustrates aspects of an array module 400A having a first array 402 aligned with a first plane 412, and a second array 404 aligned with a second plane 414. In some aspects, the first and second planes are approximately perpendicular. The configuration can be such that the first plane 412 is aligned with a top surface of a module substrate (e.g., the top surface 399 of the substrate 303) and the second plane 414 can be aligned with an edge surface of the module substrate (e.g., the edge 398 of the substrate 303). In other aspects, any orientation of the first array 402 and the second array 404 can be used (e.g., any angle can be present between the first plane 412 and the second plane 414) to match a particular device geometry and desired communication performance.

The first array 402 and the second array 404 can have differing number of antenna elements and different element configurations in different implementations. For example, in some aspects, the array module 400A can be implemented in a mmW module supporting 32 antenna feeds across two polarizations with the first array 402 configured as an 1×8 array, and the second array 404 configured as an 1×8 array. In other aspects, a similar 32 antenna feed across two polarizations can be supported with the first array 402 and the second array 404 both configured as two by four element arrays. In some aspects, the first array 402 and the second array 404 are configured with substrate edges having the same length, and a shared edge coupled by a connector that both provides a physical structure and a conductive connector to facilitate electrical coupling of elements. In such an implementation, the number of elements can be aligned, so that at the corner where the substrates supporting the antenna elements are connected, there are a same shared number of antenna elements. In other configurations, the antenna arrays can be aligned differently to match a device shape, or to provide design specific antenna performance. Other implementations can include first and second arrays 402, 404 that have different numbers of antenna elements, different element geometries within each array, or other such configurations.

In various aspects, the connected edge or corner between the two planes 412, 414 can be configured so that one or more solder bumps at respective positions in one of the planes can be used for a connection location(s) to provide signals to and/or receive signals from the antenna elements of both the first array 402 and the second array 404. For example, the solder bump connection(s) may couple a mmW IC (e.g., the mmW IC 310) to one or more antenna elements (e.g., the antenna elements 321, 322, 323, 324, 325, 326, 327, 328, and/or antenna elements aligned with another plane). Additional details of the solder bump connection(s) and positioning of the solder bump connection(s) are included below.

FIG. 4B illustrates aspects of an array module 400B having a first array 407 aligned with the first plane 412, and a second array 408 aligned with the second plane 414, and a third array 409 aligned with the second plane. In some aspects, the first and second planes are approximately perpendicular, and the second and third arrays 408, 409 are in the same shared plane. In other implementations, arrays can be in parallel offset planes, for example, when one array is mounted on a different layer of a mmW module, or more than two planes can be used for the different antenna arrays of a module. In some aspects, antenna arrays in two parallel planes overlap, for example such that they share an aperture.

In one aspect, the array module 400B can be configured with the first array 407 configured as a three by one (3×1) array, the second array 408 configured as a three by one (3×1) array, and the third array 409 configured as a two by one (2×1) array, with the multi-sided array module 400B supporting sixteen antenna feeds with two polarizations.

FIG. 4C illustrates an array module 400C having a first array 422, a second array 424, and a third array 426. FIG. 4D illustrates an array module 400D having a first array 432, a second array 434, and a third array 436. The array modules 400C and 400D illustrate arrays similar to the array module 400B, with different positioning of the three arrays.

For example, in the array module 400C, the second array 424 is a smaller array between the larger first array 422 and third array 426. In the array module 400D, the second array 434 is connected in an offset position, with one end of the first array 434 connected to an opposite end of the second array 434 at an edge between the different planes where the different arrays are positioned. This can result, for example, in a configuration where the third antenna array 436 is offset from the second antenna array 434, such that a middle array element of the second antenna array is adjacent to a side array element of the third antenna array. In other aspects, other such positional relationships between different antenna arrays can be used.

The illustrated array modules 400A, 400B, 400C, and 400D are examples, and in different implementations, different sizes and array positions and configurations can be used to improve omnidirectional communication or multidirectional communication with a single mmW module.

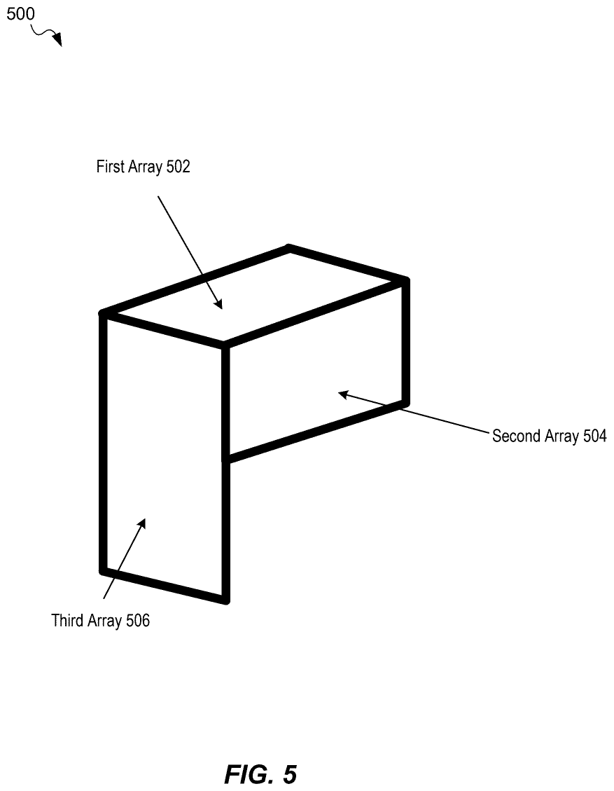

FIG. 5 is a diagram illustrating aspects of multi-sided antenna array module 500 in accordance with some aspects described herein. The array module 500 includes a first array 502, a second array 504, and a third array 506. Unlike in FIGS. 4A, 4B, 4C, and 4D, a third planar positioning is used instead of the two planes shown above. In some aspects, the three arrays are configured to support 32 antenna feeds across two polarizations, with different positions of four by one or four by two arrays. For example, in differing implementations, the first array 502 positioned approximately in a first plane can be a 4×1, 4×2, 2×4, or 4×2 configured array. The second array 504 and the third array 506 can be similarly configured in different implementations for 16 array elements total to support 32 antenna feeds (e.g., dual-polarization feeds for each element). In other implementations, more than three antenna arrays can be used, arrays and/or modules with differing numbers of elements or differing planar orientations (e.g., perpendicular, parallel, offset, non-perpendicular, etc.) can be used. For example, a module having four arrays (e.g., disposed on an opposite side of the first array 502 and third array 506 as the second array 504 is disposed) may be implemented.

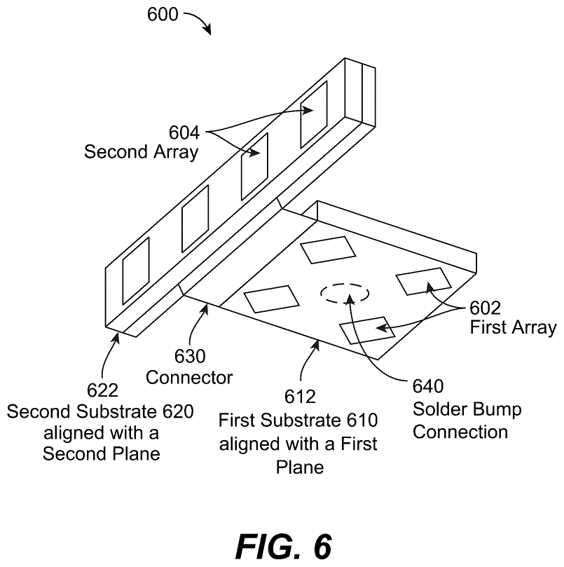

FIG. 6 is a diagram illustrating aspects of multi-sided antenna array module 600 in accordance with some aspects described herein. In addition to the first array 602 and the second array 604, the multi-sided antenna array module 600 illustrates the substrates 610 and 620 used to support corresponding arrays 602, 604, as well a connector 630 and a solder bump connection 640 that will be present for multi-sided antenna array modules 600 in accordance with aspects described herein. Similarly, the first plane 612 associated with the position of the first substrate 610 can be seen, and second plane 622 associated with the position of the second substrate 620 can be understood, with the connector 630 around an intersection between the planes.

For prior systems where the separate first array 602 and the second array 604 would be part of separate modules, each array would have one or more associated solder bump connections. For certain implementations of a single module such as the module 600, a single solder bump connection can be used, with signal to and from the arrays traveling across the connector 630 for the array disposed on the substrate not including the solder bump connection 640. The increased distance from the solder bump connection to these antennas results in additional losses for antenna elements disposed on the substrate not including the solder bump connection 640, and the placement of the solder bump connection 640 can be selected to manage these additional losses. For example, implementation designs can be created to improve other aspects of a link budget for paths including array elements further from the solder bump connection 640 to compensate for losses while electrically coupling device elements in accordance with device performance parameters. The solder bump 640 may be disposed on an opposite side of the substrate 610 as the antennas in the array 602. For example, the solder bump 640 may couple circuitry in a mmW IC (not illustrated) on the opposite side to routing in the substrate, which routing may couple to the antennas in the array 602 and to the antennas in the array 604 through the connector 630. In some examples, a solder bump can be couped to multiple antennas.

As indicated above, while bump placement for a single sided module involves placing the bump at the center of the array for a simple optimization, for a multi-sided module, multiple tradeoffs are present. Because the substrate for each antenna array will be associated with a different ground plane, and the ground plane size increases elemental gains, the placement of the solder bump connection in a different antenna substrate will result in different performance associated with the different ground plane size. In some aspects, the solder bump can be selected for a position in a (e.g., center of a) substrate or antenna array associated with the largest ground plane to achieve the increased elements gains associated with the ground plane.

Additionally, the distance to antenna elements increases losses to those elements. In some aspects, in addition to the placement of the solder bump connection in the substrate with the largest ground plane, the solder bump can be shifted toward a conductive connection (e.g., the connector 630) with an adjacent substrate for a different antenna array, to achieve a trade-off with the losses due to the increased distance to the elements on the other antenna substrate. Such losses can occur both from the distance to the element, and due to losses from the connection and/or the structure connecting the antenna substrates.

In addition, thickness constraints associated with the size of a solder bump (e.g., height above a substrate surface), mounting geometries, thermal considerations from power passing through the solder bump connection, and other considerations may be managed with the solder bump placement away from a center of an antenna array in one plane.

The distance determination for losses may be balanced when more than two antenna arrays are present. For configurations of similar arrays (e.g., same size and configuration) with more than two array substrates, a central array may include a solder bump positioned to balance losses between the elements in the adjacent antenna arrays. In some implementations, one adjacent array may have lower performance due to other design choices, and so the solder bump can be shifted in the central array substrate toward the connection with the lower performance array to balance the losses, providing a shorter connection to the lower performance array and a longer connection (e.g., with higher associated losses) to the higher performing array, providing a performance balancing impact. In some examples, multiple arrays are daisy chained together. For example, an array including a solder bump may be coupled by a first conductive connection to a second array, which may be coupled by a second conductive connection to a third array. In some examples, an array including a solder bump may be coupled by respective conductive connections to multiple other arrays.

In FIG. 6, the solder bump connection 640 is illustrated by a single area on the first substrate 610. In some aspects, the solder bump connection 640 is representative of or can include multiple solder balls or solder bumps to support multiple paths for device performance. For example, in some implementations, the solder bump connection 640 comprises separate solder bump nodes for a plurality of polarization and frequency band signal paths. This can include, for example, a first solder bump node associated with a first high frequency band path for a first polarization, a second solder bump node associated with a second high frequency band path for a second polarization different from the first polarization, a third solder bump node associated with a first low frequency band path with the first polarization, and a fourth solder bump node associated with a second low frequency band path with the second polarization. In some examples, each (driven) antenna element (e.g., across all arrays in the module) is coupled to at least one respective solder bump, and may be coupled to multiple respective solder bumps (e.g. such that each antenna element may supports multiple polarizations and/or multiple bands). Any number of connections can be present to support multiple communication paths, to manage thermal performance for a single communication path, or for other such communication design criteria.

The physical solder bump(s) position may be on a backside of an antenna substrate, with antenna elements on one side of the antenna substrate (e.g., array 602 elements on a visible side of or visibly attached to substrate 610 in FIG. 6) and the solder bump(s) placement on a backside of the antenna substrate (e.g., the physical solder bump(s) for the solder bump connection 640 on a backside of the substrate 610 not visible from the perspective in FIG. 6). When multiple solder bumps are implemented, the size of the illustrated solder bump connection 640 may be large enough to encompass all of the physical solder bumps. While connected 640 is illustrated as a circle, it may be an oval, a box, a line, etc. In some implementations with larger physical solder bumps, the illustrated solder bump connection 640 does not completely encircle all of the physical solder bump connections, but is representative of a center of the physical solder bump connections. For example, the solder bump connection 640 may be representative of a midway point between the second and third elements in a 1×4 array, or halfway between the two rows (and between the second and third elements of each row) of a 2×4 array. In some implementations, the illustrated solder bump connection 640 is representative of a point which minimizes the squares of the distances from point to the antennas in the array.

In some aspects a device can include support for multiple communication bands, with differing signal paths for different combinations of band frequencies. Each signal path in such a device can have associated solder bump positions. In some aspects, the position of such bumps can be selected based on details of particular signal paths. For example, in some aspects, higher frequency communication bands are associated with solder bumps positioned for relatively lower path losses, and lower frequency signal paths are associated with solder bumps positioned for relatively higher path losses due to the ability of the lower frequency signal paths and associated communication bands to tolerate the additional signal path loss. In other aspects, other criteria can be used to adjust solder bump positioning for different signal paths in a multi-band antenna module. As described herein, different placement criteria and placement positioning limits can be used for different signal paths within the same multi-band antenna module, such that any or all different placement aspects described herein can be used in the same multi-band antenna module with different signal paths for different band groups where all of the solder bumps are on a single substrate within the antenna module and/or coupled to a single mmW IC.

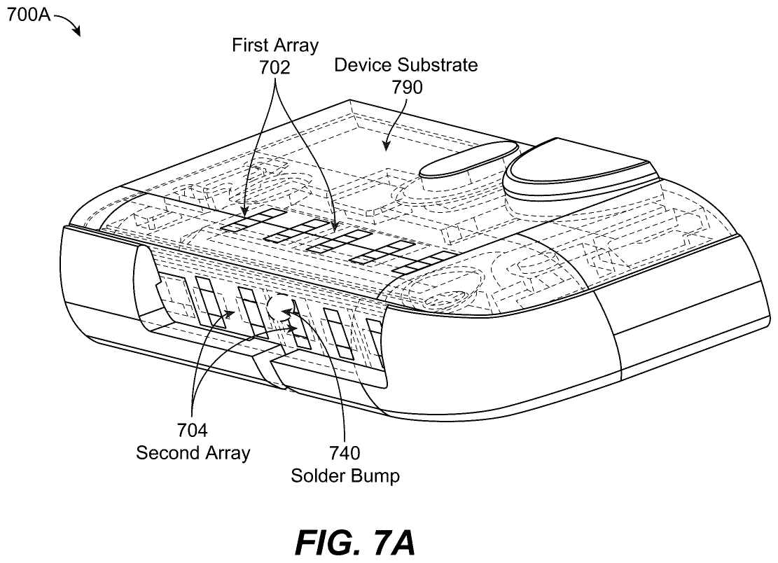

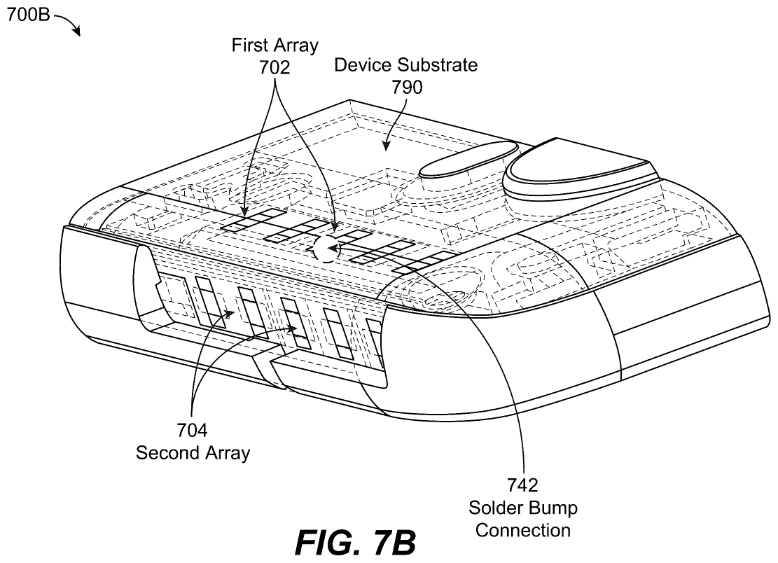

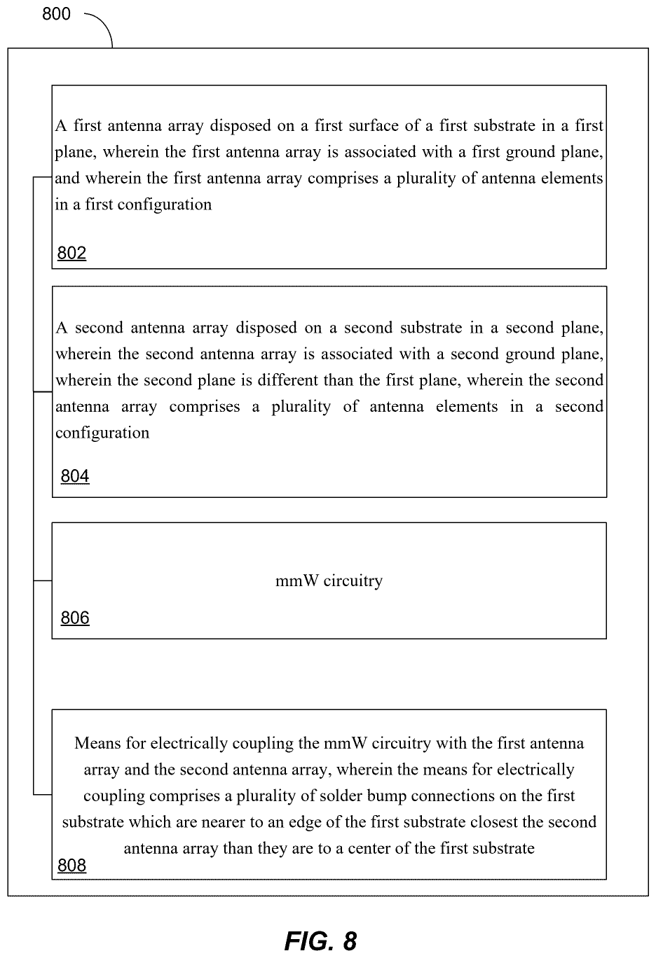

FIG. 7A is a diagram illustrating aspects of multi-sided antenna array module 700A in accordance with some aspects described herein. The antenna array module 700A illustrates not only the antenna modules described above, but also a device substrate 790 to which the module 700A, for example one of the antenna substrates (e.g., the substrates 610, 620), may be mounted. The device substrate 790 has a back surface (e.g., facing a back of a device, such as a backside of a phone which is opposite a display), with the first array 702 mounted to the back surface, and an edge (e.g., a top edge parallel with a top of the device), with the second array 704 adjacent to or mounted to the edge. Because of the orientation of the first array 702 in a plane parallel with the device substrate 790, the ground plane for the first array 702 is likely to behave as if larger. Such enlarged ground plane may be considered when determining a location of a solder bump for the module. As an alternative or in addition to considering the ground plane size for solder bump placement, the overall feedline losses to the most number of antenna elements can be used, resulting in some aspects, in the placement of the solder bump 740 in a substrate with a smaller (or smaller effective) ground plane, as shown in FIG. 7A (for a configuration in which the top facing array has more antenna elements than the back facing array). Particularly for implementations where an antenna array with a larger number of elements is positioned with a smaller ground plane, the reduction in feedline losses to the greatest number of antenna elements can offset the benefits of elemental gain from a larger ground plane. In other examples, the module 700A is not physically mounted to the device substrate 790, but an array of the module 700A is parallel to the substrate 790 or other structure that acts as or provides a ground plane.

The configuration of FIG. 7A results in the first array 702 having larger feedline losses, and the elemental gain associated with the first array 702 being larger. In some implementations, this can result in a design balance with improved peak performance.

FIG. 7B is a diagram illustrating aspects of multi-sided antenna array module 700B in accordance with some aspects described herein. The antenna array module 700B but also the device substrate 790 with the first array 702 mounted to or parallel with the back surface, and the second array 704 mounted to or adjacent the top edge. In contrast with FIG. 7A, FIG. 7B shows a solder bump connection 742 positioned near the first array 702 for the larger ground plane. In different implementations, the specific design considerations can be used to shift the solder bump connection placement between a central module position in a largest (effective) ground plane with an increased elemental gain from the ground plane, and a position towards the most distant elements in order to reduce feedline losses. Such a placement can be selected on a sliding position to balance the performance results for a particular design and to offset other design considerations.

FIG. 8 is a functional block diagram of an apparatus in accordance with some aspects. The apparatus 800 comprises a first antenna array 802 disposed on a first surface of a first substrate in a first plane, wherein the first antenna array is associated with a first ground plane, and wherein the first antenna array comprises a plurality of antenna elements in a first configuration. The apparatus 800 further comprises a second antenna array 804 disposed on a second substrate in a second plane, wherein the second antenna array is associated with a second ground plane, wherein the second plane is different than the first plane, wherein the second antenna array comprises a plurality of antenna elements in a second configuration. The apparatus 800 further comprises mmW circuitry 806. The apparatus 800 further comprises means 808 for electrically coupling the mmW circuitry 806 with the first antenna array 802 and the second antenna array 804, wherein the means for electrically coupling comprises a plurality of solder bump connections on the first substrate which are nearer to an edge of the first substrate closest the second antenna array than they are to a center of the first substrate. The means 808 may further include routing (e.g., in the first and/or second substrate) and/or a connector (e.g., that physically couples the first and second substrates and/or electrically couples the mmW circuitry to the second antenna array), etc. In some aspects, the apparatus 800 is implemented as a mmW module or includes a mmW module that comprises the first antenna array 802, the second antenna array 804, the mmW circuitry 806, and the means 808.

Devices, networks, systems, and certain means for transmitting or receiving signals described herein may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles, and will be referred to herein as “sub-7 GHz”. A similar nomenclature issue sometimes occurs with regard to FR2, which is often referred to (interchangeably) as a “millimeter wave” (mmW) band in documents and articles, despite including frequencies outside of the extremely high frequency (EHF) band (30 GHZ-300 GHz) which is identified by the International Telecommunications Union (ITU) as a “mm Wave” or mmW band. Unless specifically stated otherwise, it should be understood that the term “mmWave”, mmW, or the like if used herein may broadly represent frequencies that may include mid-band frequencies, may be within FR2, or may be within the EHF band.

The circuit architecture described herein may be implemented on one or more ICs, analog ICs, mmWICs, mixed-signal ICs, ASICs, printed circuit boards (PCBs), electronic devices, etc. The circuit architecture described herein may also be fabricated with various IC process technologies such as complementary metal oxide semiconductor (CMOS), N-channel MOS (NMOS), P-channel MOS (PMOS), bipolar junction transistor (BJT), bipolar-CMOS (BiCMOS), silicon germanium (SiGe), gallium arsenide (GaAs), heterojunction bipolar transistors (HBTs), high electron mobility transistors (HEMTs), silicon-on-insulator (SOI), etc.

An apparatus implementing the circuit described herein may be a stand-alone device or may be part of a larger device. A device may be (i) a stand-alone IC, (ii) a set of one or more ICs that may include memory ICs for storing data and/or instructions, (iii) an RFIC such as an RF receiver (RFR) or an RF transmitter/receiver (RTR) or corresponding mmW elements, (iv) an ASIC such as a mobile station modem (MSM), (v) a module that may be embedded within other devices, (vi) a receiver, cellular phone, wireless device, handset, or mobile unit, (vii) etc.

Although selected aspects have been illustrated and described in detail, it will be understood that various substitutions and alterations may be made therein without departing from the spirit and scope of the present application, as defined by the following claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Aspects described herein include, but are not limited to:

Aspect 1. A millimeter wave (mmW) module comprising: a first antenna array disposed on a first surface of a first substrate in a first plane, wherein the first antenna array is associated with a first ground plane, and wherein the first antenna array comprises a plurality of antenna elements in a first configuration; a second antenna array disposed on a second substrate in a second plane, wherein the second antenna array is associated with a second ground plane, wherein the second plane is different than and nonparallel with the first plane, wherein the second antenna array comprises a plurality of antenna elements in a second configuration, and wherein the second configuration is different than the first configuration; one or more solder bump connections disposed on the first substrate; millimeter wave (mmW) circuitry connected to the one or more solder bump connections; and a connector physically coupling the second substrate to the first substrate, wherein the mmW circuitry is coupled via the one or more solder bump connections to the first antenna array, the connector, and the second antenna array.

Aspect 2. The mmW module of Aspect 1, wherein the first ground plane is larger than the second ground plane, and wherein the solder bump connection is disposed on a second surface of the first substrate opposite the first surface.

Aspect 3. The mmW module of any of Aspects 1 through 2, wherein the first substrate is disposed on a back surface of a device substrate; wherein the second substrate is disposed at a top end of the device substrate.

Aspect 4. The mmW module of any of Aspects 1 through 3, wherein the second substrate is disposed on a back surface of a device substrate; wherein the first substrate is disposed at a top end of the device substrate; and wherein a number of antenna elements in the first antenna array is greater than a number of antenna elements in the second antenna array.

Aspect 5. The mmW module of any of Aspects 1 through 4, wherein the one or more solder bump connections comprises separate solder bump nodes for a plurality of polarization and frequency band signal paths.

Aspect 6. The mmW module of Aspect 5, wherein the one or more solder bump connections comprises: a first solder bump node associated with a first high frequency band path for a first polarization; a second solder bump node associated with a second high frequency band path for a second polarization different from the first polarization; a third solder bump node associated with a first low frequency band path with the first polarization; and a fourth solder bump node associated with a second low frequency band path with the second polarization.

Aspect 7. The mmW module of any of Aspects 1 through 6, wherein the first configuration is a one element by four element array configuration; and wherein the second configuration is a two element by two element array configuration.

Aspect 8. The mmW module of any of Aspects 1 through 8, wherein the first plane is approximately perpendicular to the second plane.

Aspect 9. The mmW module of Aspect 2, further comprising: a third antenna array disposed on a third substrate in a third plane, wherein the third plane is different from the first plane and the second plane, and wherein the third antenna array comprises a plurality of antenna elements in a third configuration.

Aspect 10. The mmW module of Aspect 9, wherein the third plane is approximately perpendicular to the first plane and the second plane.

Aspect 11. The mmW module of Aspect 9, wherein the first configuration is a two element by four element array configuration, wherein the second configuration is a one element by four element array configuration, and wherein the third configuration is a one element by four element array configuration.

Aspect 12. The mmW module of Aspect 9, wherein the third plane is approximately perpendicular to the first plane and approximately parallel to the second plane.

Aspect 13. The mmW module of Aspect 12, wherein the first configuration is a one element by three element array configuration, wherein the second configuration is a two element by one element array configuration, and wherein the third configuration is a one element by three element array configuration.

Aspect 14. The mmW module of Aspect 12, wherein: the first configuration is a one element by two element array configuration, the second configuration is a one element by three element array configuration, and the third configuration is a one element by three element array configuration; and the third antenna array is offset from the second antenna array, such that a middle array element of the second antenna array is adjacent to a side array element of the third antenna array.

Aspect 15. The mmW module of Aspect 9, wherein the third plane is approximately parallel to the first plane and approximately perpendicular to the second plane.

Aspect 16. The mmW module of any of Aspects 1 through 15, wherein the mmW module is integrated within a wireless transceiver of a wireless communication apparatus.

Aspect 17. A millimeter wave (mmW) module comprising: a first antenna array disposed on a first substrate in a first plane, wherein the first antenna array is associated with a first ground plane; a second antenna array disposed on a second substrate in a second plane, wherein the second antenna array is associated with a second ground plane, wherein the second plane is different than and nonparallel with the first plane; a third antenna array disposed on a third substrate, wherein the third antenna array is associated with a third ground plane; one or more solder bump connections disposed on the first substrate; mmW circuitry connected to the one or more solder bump connections; a first connector physically coupling the second substrate to the first substrate; and a second connector physically coupling the third substrate to the first substrate or the second substrate, wherein the mmW circuitry is coupled via the one or more solder bump connections to the first antenna array, the first connector, the second antenna array, the second connector, and the third antenna array.

Aspect 18. The mmW module of Aspect 17, wherein the one or more solder bump connections comprises separate solder bump nodes for a plurality of polarization and frequency band signal paths.

Aspect 19. The mmW module of Aspect 18, wherein the one or more solder bump connections comprise: a first solder bump node associated with a first high frequency band path for a first polarization; a second solder bump node associated with a second high frequency band path for a second polarization different from the first polarization; a third solder bump node associated with a first low frequency band path with the first polarization; and a fourth solder bump node associated with a second low frequency band path with the second polarization.

Aspect 20. A millimeter wave (mmW) module comprising: a first antenna array disposed on a first surface of a first substrate in a first plane, wherein the first antenna array is associated with a first ground plane, and wherein the first antenna array comprises a plurality of antenna elements in a first configuration; a second antenna array disposed on a second substrate in a second plane, wherein the second antenna array is associated with a second ground plane, wherein the second plane is different than the first plane, wherein the second antenna array comprises a plurality of antenna elements in a second configuration; mmW circuitry; and means for electrically coupling the mmW circuitry with the first antenna array and the second antenna array, wherein the means for electrically coupling comprises a plurality of solder bump connections on the first substrate which are nearer to an edge of the first substrate closest the second antenna array than they are to a center of the first substrate.

Aspect 21: A device comprising means for implementing any of Aspects 1 to 20.

Aspect 22: A method comprising: transmitting or receiving millimeter wave signals using any of Aspects 1 to 20.

What is claimed is:

1. A millimeter wave (mmW) module comprising:
a first antenna array disposed on a first surface of a first substrate in a first plane, wherein the first antenna array is associated with a first ground plane, and wherein the first antenna array comprises a plurality of antenna elements in a first configuration;
a second antenna array disposed on a second substrate in a second plane, wherein the second antenna array is associated with a second ground plane, wherein the second plane is different than and nonparallel with the first plane, wherein the second antenna array comprises a plurality of antenna elements in a second configuration, and wherein the second configuration is different than the first configuration;
one or more solder bump connections disposed on the first substrate;
millimeter wave (mmW) circuitry connected to the one or more solder bump connections; and
a connector physically coupling the second substrate to the first substrate, wherein the mmW circuitry is coupled via the one or more solder bump connections to the first antenna array, the connector, and the second antenna array.

2. The mmW module of claim 1, wherein the first ground plane is larger than the second ground plane, and wherein a solder bump connection of the one or more solder bump connections is disposed on a second surface of the first substrate opposite the first surface.

3. The mmW module of claim 1,
wherein the first substrate is disposed on a back surface of a device substrate;
wherein the second substrate is disposed at a top end of the device substrate.

4. The mmW module of claim 1,
wherein the second substrate is disposed on a back surface of a device substrate;
wherein the first substrate is disposed at a top end of the device substrate; and
wherein a number of antenna elements in the first antenna array is greater than a number of antenna elements in the second antenna array.

5. The mmW module of claim 1, wherein the one or more solder bump connections comprises separate solder bump nodes for a plurality of polarization and frequency band signal paths.

6. The mmW module of claim 5, wherein the one or more solder bump connections comprises:
a first solder bump node associated with a first high frequency band path for a first polarization;
a second solder bump node associated with a second high frequency band path for a second polarization different from the first polarization;
a third solder bump node associated with a first low frequency band path with the first polarization; and
a fourth solder bump node associated with a second low frequency band path with the second polarization.

7. The mmW module of claim 1, wherein the first configuration is a one element by four element array configuration; and
wherein the second configuration is a two element by two element array configuration.

8. The mmW module of claim 1, wherein the first plane is approximately perpendicular to the second plane.

9. The mmW module of claim 2, further comprising:
a third antenna array disposed on a third substrate in a third plane, wherein the third plane is different from the first plane and the second plane, and wherein the third antenna array comprises a plurality of antenna elements in a third configuration.

10. The mmW module of claim 9, wherein the third plane is approximately perpendicular to the first plane and the second plane.

11. The mmW module of claim 9, wherein the first configuration is a two element by four element array configuration, wherein the second configuration is a one element by four element array configuration, and wherein the third configuration is a one element by four element array configuration.

12. The mmW module of claim 9, wherein the third plane is approximately perpendicular to the first plane and approximately parallel to the second plane.

13. The mmW module of claim 12, wherein the first configuration is a one element by three element array configuration, wherein the second configuration is a two element by one element array configuration, and wherein the third configuration is a one element by three element array configuration.

14. The mmW module of claim 12, wherein:
the first configuration is a one element by two element array configuration, the second configuration is a one element by three element array configuration, and the third configuration is a one element by three element array configuration; and
the third antenna array is offset from the second antenna array, such that a middle array element of the second antenna array is adjacent to a side array element of the third antenna array.

15. The mmW module of claim 9, wherein the third plane is approximately parallel to the first plane and approximately perpendicular to the second plane.

16. The mmW module of claim 1, wherein the mmW module is integrated within a wireless transceiver of a wireless communication apparatus.

17. A millimeter wave (mmW) module comprising:
a first antenna array disposed on a first substrate in a first plane, wherein the first antenna array is associated with a first ground plane;
a second antenna array disposed on a second substrate in a second plane, wherein the second antenna array is associated with a second ground plane, wherein the second plane is different than and nonparallel with the first plane;
a third antenna array disposed on a third substrate, wherein the third antenna array is associated with a third ground plane;
one or more solder bump connections disposed on the first substrate;
mmW circuitry connected to the one or more solder bump connections;
a first connector physically coupling the second substrate to the first substrate; and
a second connector physically coupling the third substrate to the first substrate or the second substrate, wherein the mmW circuitry is coupled via the one or more solder bump connections to the first antenna array, the first connector, the second antenna array, the second connector, and the third antenna array.

18. The mmW module of claim 17, wherein the one or more solder bump connections comprises separate solder bump nodes for a plurality of polarization and frequency band signal paths.

19. The mmW module of claim 18, wherein the one or more solder bump connections comprise:
a first solder bump node associated with a first high frequency band path for a first polarization;
a second solder bump node associated with a second high frequency band path for a second polarization different from the first polarization;
a third solder bump node associated with a first low frequency band path with the first polarization; and
a fourth solder bump node associated with a second low frequency band path with the second polarization.

20. A millimeter wave (mmW) module comprising:
a first antenna array disposed on a first surface of a first substrate in a first plane, wherein the first antenna array is associated with a first ground plane, and wherein the first antenna array comprises a plurality of antenna elements in a first configuration;
a second antenna array disposed on a second substrate in a second plane, wherein the second antenna array is associated with a second ground plane, wherein the second plane is different than the first plane, wherein the second antenna array comprises a plurality of antenna elements in a second configuration;
mmW circuitry; and
means for electrically coupling the mmW circuitry with the first antenna array and the second antenna array, wherein the means for electrically coupling comprises a plurality of solder bump connections on the first substrate which are nearer to an edge of the first substrate closest the second antenna array than they are to a center of the first substrate.
